(19) United States
(12) Patent Application Publication
(10) Pub. No.: US 2004/0205345 A1
(43) Pub. Date: Oct. 14, 2004

(54) System for identification and revocation of audiovisual titles and replicators

(76) Inventors: Michael S. Ripley, Hillsboro, OR (US); C. Brendan S. Traw, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/412,443

(22) Filed: Apr. 11, 2003

(51) Int. Cl. H04L 9/00

(52) U.S. Cl. 713/176

(57) ABSTRACT

A system and method relating to the production and rendering of pre-recorded audiovisual titles, such as movies or other programs sold on digital versatile discs (DVDs), or other digital storage mediums. In at least one embodiment, the present invention is intended to thwart unauthorized mass distribution of titles. Embodiments of the invention may be used to identify the replicator of any given pre-recorded title, to prevent rendering of a title for which the replicator which produced the title is not identified or not licensed, or where the contents of the title have been tampered with, and to revoke rendering by a player device of one or more unauthorized titles originating from a given replicator.

### BACKGROUND

1. FIELD

The present invention relates generally to digital content protection systems and, more specifically, to protecting production and playback of pre-recorded audiovisual titles.

2. Description

Various mechanisms exist for protecting digital content when the content is distributed on a storage medium such as a compact disk read only memory (CD-ROM) or a digital versatile disk (DVD). Typically, such mechanisms use some form of cryptography to protect the content. In some instances, these mechanisms have been breached, and the content has been distributed in an unauthorized manner. In one example, the Content Scrambling System (CSS) for DVDs has been broken and programs to defeat CSS are available. Content providers and distributors must devise new methods to secure digital content for mass distribution in ways that deter piracy.

### BRIEF DESCRIPTION OF THE DRAWINGS

The features and advantages of the present invention will become apparent from the following detailed description of the present invention in which:

FIG. 1 is a diagram of a system for identification and revocation of audiovisual titles and replicators according to an embodiment of the present invention;

FIG. 2 is a diagram of an example of a revocation list according to an embodiment of the present invention;

FIGS. 3-5 are flow diagrams illustrating content protection processing according to an embodiment of the present invention;

FIG. 6 is a flow diagram illustrating revocation list processing according to an embodiment of the present invention; and

FIG. 7 is a flow diagram illustrating certificate processing according to an embodiment of the present invention.

### DETAILED DESCRIPTION

An embodiment of the present invention is a system and method relating to the production and playback of pre-recorded audiovisual titles, such as movies or other programs sold on digital versatile discs (DVDs) or other digital optical storage mediums. In at least one embodiment, the present invention is intended to thwart mass distribution of unauthorized titles. Consistent with industry terminology, a manufacturer of such discs will be referred to herein as a “replicator.” Embodiments of the present invention provide a robust system for identifying the replicator of any given pre-recorded title, for preventing playback of titles for which the replicator is not identified or is not authorized, and for revoking playback by a player device of one or more unauthorized titles originating from a given replicator.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

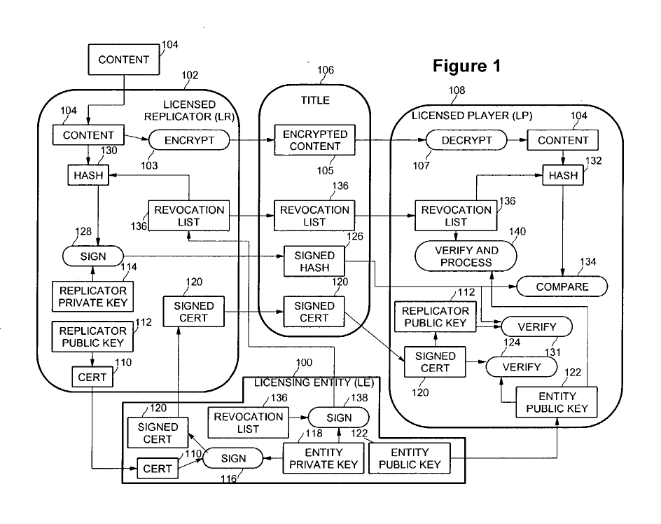

FIG. 1 is a diagram of a system for identification and revocation of audiovisual titles and replicators according to an embodiment of the present invention. In this system, a licensing entity (LE) 100 communicates with a licensed replicator (LR) 102 to coordinate the replication of content 104 comprising a title 106 for subsequent use by a licensed player (LP) 108. In at least one embodiment, the title may comprise the content and other information described below and may be stored on a transportable and distributable optical storage medium (e.g., a CDROM or a DVD, or other formats yet to be defined), which may be any storage technology capable of storing digital content. For example, the title may be a film, a television (TV) program or multiple episodes of a TV program, a recording of a sporting event, recorded music, or any other audio and/or visual work. In another embodiment, the title may be communicated over a network (e.g., downloaded) and stored in a memory in a processing system (e.g., in a hard drive, a random access memory (RAM), and so on). A licensed player may be any device or system, whether hardware, firmware, or software, or a combination thereof, capable of accessing the title and rendering the title for a user. In at least one embodiment, the LP may comprise a consumer electronics device (e.g., a DVD player, TV, stereo receiver, satellite receiver, personal video recorder (PVR), or other digital video player/recorder), a software application running on a personal computer (PC) system, or a personal video player. Content 104 may comprise any combination of audio, video, text, image, or other data. The content may be obtained by the LR from a content provider (e.g., a movie studio, a record company, a TV studio or TV programming network) or any creator or distributor of content. Content may be encrypted at block 103 by a LR 102 using known cryptographic methods to form encrypted content 105, which may be subsequently decrypted at block 107 by a LP 108.

A licensed replicator (LR) 102 may include a signed replicator certificate (Cert) 120 as part of each title that is produced and distributed. In one embodiment, the signed replicator certificate may be stored as data in unencrypted form. Each signed replicator certificate may be generated by a replicator and a licensing entity (LE) as described further below, and includes a unique replicator public key 112 of an asymmetric key pair generated or otherwise obtained by that replicator. Generally, a replicator may be any entity producing a title for distribution. The LR keeps the corresponding replicator private key 114 as confidential information. Prior to use, a replicator certificate 110 may be submitted to a LE 100 for signature. If the LE determines that the replicator is a LR in “good standing”, the LE signs 116 the replicator certificate using an entity private key 118, and returns the signed certificate 120 to the LR. In one embodiment, to be in “good standing” means that the replicator has an agreement for production of one or more titles with the LE (i.e., it is authorized). In at least one embodiment, the LE may represent the interests of one or more content providers. In one embodiment, an LR may perform this process once and use the resulting signed replicator certificate for every title that the LR produces, or alternatively, the LR may repeat the process as desired, such as by obtaining a new signed replicator certificate for every individual title the LR produces. Generally, a LE may be any trusted entity.

The LE 100 provides its entity public key 122 (which corresponds to the entity private key 118) to each licensed manufacturer for inclusion in each licensed playback device or application (i.e., each LP) produced by the manufacturer. A manufacturer of a playback device has an agreement with the LE to produce a player that is licensed for playback of titles according to the present invention. Licensed players protect the integrity of the entity public key 122, but need not keep the entity public key secret. Prior to playback of a given pre-recorded title 106, an LP 108 reads the signed replicator certificate 120 included with the title and verifies 124 the signature using the entity public key 122. If the verification fails, playback of the content is aborted.

LR 102 also includes a signed content hash 126 on each pre-recorded title 106 produced by the LR. This cryptographic hash may be calculated by the LR, and cover one or more portions of the content that are irreplaceably essential to enjoyment of the content by the user. In some embodiments, signed hash 126 may comprise multiple hashes. In at least one embodiment, the signed hash may be a hash of all of the content 104. The LR signs 128 the hash 130 using replicator private key 114, and includes signed hash 126 on title 106. The inclusion of a signed content hash enables an LP 108 to verify a correspondence between the replicator certificate 120 and the content with which it is used. Prior to playback of content of a title, LP 108 verifies 131 the content hash signature using the replicator public key 112 included in the signed replicator certificate 120. If this verification fails, playback is aborted by the LP. During playback of the title, the LP calculates a content hash 132 using the same algorithm used by the LR, compares the signed hash 126 received in the title with the calculated hash 132, and aborts playback if at any time the calculated hash does not match the hash provided by the LR in the title.

Under some circumstances, authorized access to one or more titles produced by a LR may be revoked by a LE. When this occurs, corresponding revocation information may be added by LE 100 to a revocation list 136, which the LE 100 signs 138 using the LE's entity private key 118 and provides to all LRs. In embodiments of the present invention, the revocation list comprises indicators, identifiers, or other information indicating zero or more replicators that the LE no longer authorizes to produce titles and/or zero or more titles that the LE desires to deter access to by playback devices. The present revocation list is different in composition than prior art revocation lists in that it does not include playback device identifiers. In one embodiment, the information may comprise identifiers of replicators, replicator certificates, and/or titles. LRs include the most recent signed revocation list 136 on each title that the LR produces, in a manner consistent with normal production cycles. In one embodiment, to ensure that the revocation list included with a given title is processed in conjunction with playback of that title, the LR 102 may also include the revocation list 136 as part of the content hash calculation described above. As an alternative, the revocation list could be included as part of the signed replicator certificate described above. As another alternative in the case of pre-recorded titles encrypted by a content protection scheme, a cryptographic hash of the revocation list could be used as part of the encryption and decryption processes. Since a revocation list is unlikely to be included with a title that it revokes, LPs 108 should retain the latest revocation list encountered in persistent memory (not shown in FIG. 1).

Prior to playback of a title 106, the LP reads the revocation list 136, if any, provided with that title, and uses entity public key 122 to verify 140 the signature. If that verification fails, playback is aborted by the LP. If a revocation list was read, the LP may compare received revocation list 136 to the LP's persistently stored revocation list, if one already exists on the LP. If no revocation list was previously stored, or the list version value of the previously stored revocation list is lower than (or otherwise older than) that of the newly read revocation list, or the list version values are the same but the newly read revocation list is larger (e.g., more complete) than the previously stored one, then the LP replaces the previously stored revocation list, if any, with the newly read revocation list. Then, using the (now) persistently stored revocation list, the LP examines the revocation list to determine if the title 106 to be played (or certificate associated with that title) is revoked, and if the title is revoked, playback is aborted. The LP also examines the revocation list to determine if the replicator that manufactured the title is revoked. If the replicator is revoked, the LP aborts playback of the title. This helps to deter rogue or unauthorized replicators from reproducing titles. If playback proceeds, the LP uses the newly read revocation list (which may or may not be the persistently stored list) and uses the revocation list as part of the content hash calculation process (or signed replicator certificate verification or decryption process 107) as mentioned above.

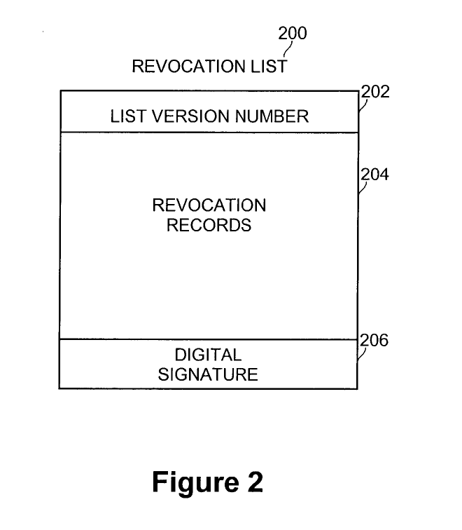

FIG. 2 is a diagram of an example of a revocation list according to an embodiment of the present invention. In one embodiment, a revocation list 200 may comprise a list version number 202, followed by one or more revocation records 204, followed by a digital signature 206 covering the foregoing. In one embodiment, a revocation record 204 may comprise a content hash value, indicating that the corresponding title is revoked, or the record may contain a licensed replicator public key value 112 (or some other suitable identifier included in replicator certificate 120), indicating that all titles associated with the certificate including that public key are revoked. In another embodiment, a revocation record may include an identifier of a replicator that is no longer authorized to produce titles.

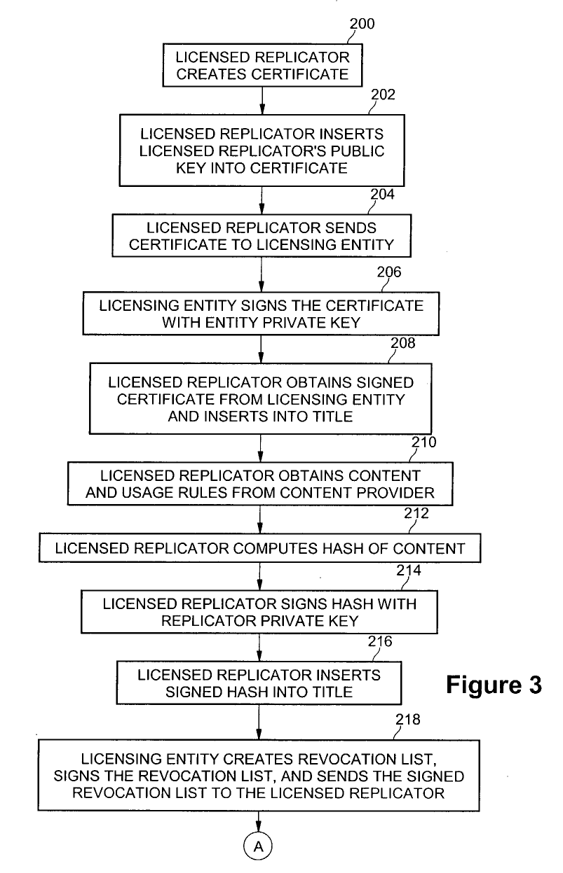

FIGS. 3-5 are flow diagrams illustrating content protection processing according to an embodiment of the present invention. Starting with FIG. 3, at block 200, a licensed replicator (LR) 102 produces a certificate 110. At block 202, the LR inserts the LR's public key 112 into the certificate. At block 204, the LR sends the certificate to the licensing entity (LE). At block 206, the LE signs the certificate with the LE's private key 118 to produce signed certificate 120. At block 208, the LR obtains the signed certificate. In another embodiment, the LE may obtain the LR's public key (perhaps as a result of a contractual arrangement between the LR and the LE), produce the signed certificate, and send the signed certificate to the LR. In one embodiment, blocks 200-208 may be performed prior to production of a title by a LR. Additionally, in block 208, the LR inserts the signed certificate 120 into a title 106.

At block 210, the LR obtains content 104, and optionally, usage rules for the content (not shown in FIG. 1). In one embodiment, the LR obtains the content from a content provider. At block 212, the LR computes a cryptographic hash 130 (e.g., a digest) of at least a portion of the content. In one embodiment, the usage rules may be included in the hash processing. At block 214, the LR signs the hash with the LR's private key 114. In one embodiment, the hash and signing operations may be combined into a single logical operation. At block 216, the LR inserts the signed hash 120 into the title 106. In at least one embodiment, this processing may occur at approximately the same time as processing of block 208.

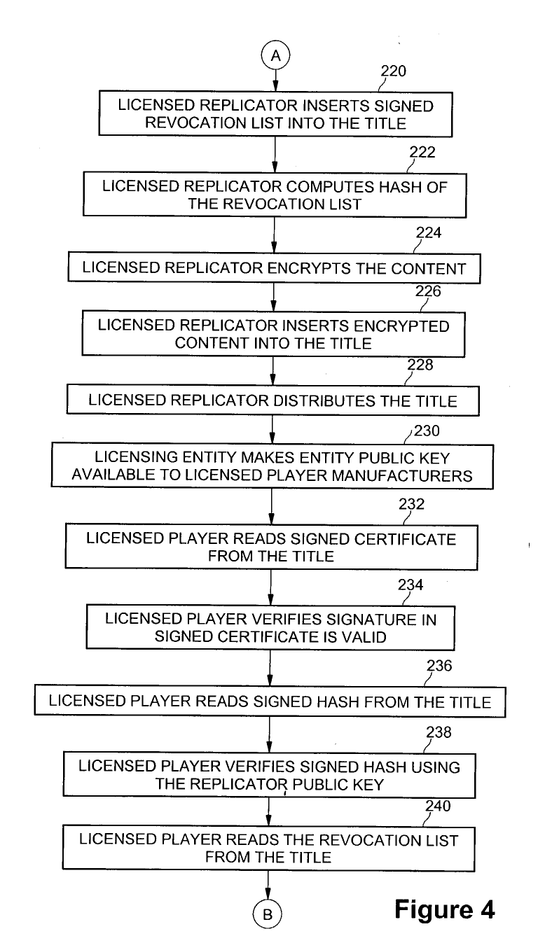

At block 218, the LE creates a revocation list 136, signs the revocation list using the LE's private key 118, and sends the signed revocation list to the LR. In at least one embodiment, this processing may occur at approximately the same time as processing of blocks 206 and 208. At block 220 on FIG. 4, the LR inserts the signed revocation list into the title. In at least one embodiment, this processing may occur at approximately the same time as processing of block 208. At block 222, the LR optionally computes the hash 138 of the revocation list. In one embodiment, the hash of the revocation list may be included in encryption processing of the content, for example, as part of generation of an encryption key. This associates the revocation list with the content. At block 224, the LR encrypts the content. In one embodiment, the content is not encrypted. At block 226, the LR inserts the encrypted content 105 into the title. At block 228, the LR, either directly or indirectly, distributes the title to one or more users. In one example scenario, the LR sells copies of the title to a wholesaler, who may then sell copies to a retailer. The retailer may then sell the copies to consumers. The title includes the encrypted content 105, a latest version of a signed revocation list 136, a signed hash 126, and a signed certificate 120. Tampering with any of these items in the title will cause an LP to fail to play the title, rendering the title useless for the consumer.

At block 230, at some point in time prior to manufacturing of an LP, the LE makes the entity public key 122 available to licensed player manufacturers. In one embodiment, communication of the entity public key may take place as part of making an agreement between the LE and the manufacturer. The manufacturer stores the entity public key in a memory or other circuitry within each licensed player manufactured by the manufacturer. The LP is then put in the stream of commerce to be purchased by a consumer and used for rendering content (e.g., watching a movie, listening to music, etc.).

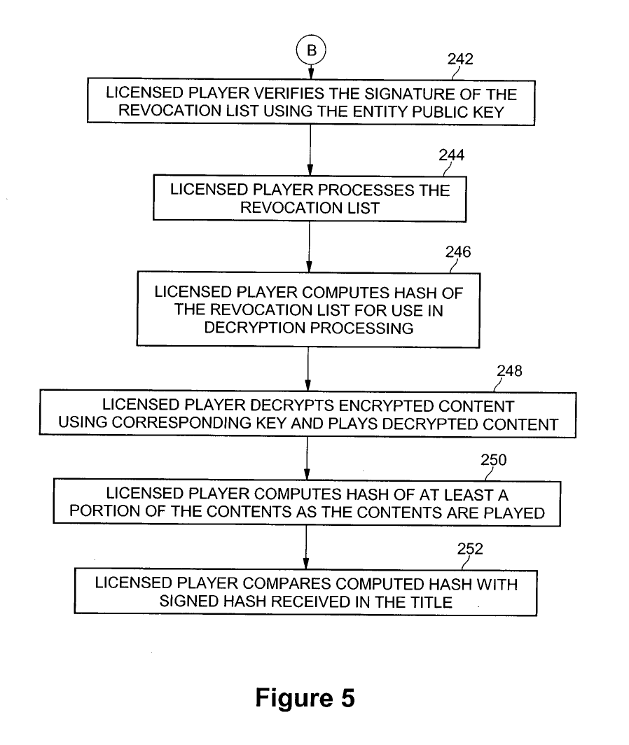

The consumer obtains the title and the LP. The LP proceeds to validate the items in the title to ensure that the title has not been tampered with, the content is secure, the title was manufactured by an authorized and identifiable LR, and the title has not been revoked. At block 232, the LP reads the signed certificate 120 from the title. At block 234, the LP verifies that the signature in the signed certificate is valid, using the entity public key 122 obtained at block 230. If the signed certificate is invalid, the LP aborts any attempted playback of the content. At block 236, the LP reads the signed hash 126 from the title. At block 238, the LP verifies the signed hash using the LR's public key 112, which is included in the signed certificate 120. If the signed hash is invalid, the LP aborts any attempted playback of the content. At block 240, the LP reads the signed revocation list 136 from the title. At block 242 on FIG. 5, the LP verifies the signature of the signed revocation list using the entity public key 122. If the revocation list is valid, the LP further processes the list. Otherwise, if the revocation list is invalid, the LP aborts any attempted playback of the content.

Further processing of the revocation list by the LP at block 244 may occur as follows. The LP stores a current revocation list in a persistent memory on the LP. The LP may check the currently stored list and the newly received and validated list to determine if the newly received list is newer than the currently stored list. In one embodiment, the list version data in the revocation list may be consulted. Recall that the LE generates and signs the list, thereby deterring replicators or others from tampering with the list. Generation of an updated revocation list may be required when titles need to be revoked, authorized replicators are no longer licensed, or for other reasons. If the newly received list is newer, than this list may be stored in the persistent memory, overwriting the old list. In one embodiment, if no revocation list is in the title, then the currently stored revocation list may be used. In another embodiment, if no revocation list is in the title, the LP aborts processing of the title. The LP examines the revocation list to determine if the title or associated certificate is on the list as a revoked title/certificate, or if the LR who reproduced the title is on the list as being a revoked replicator. If either of these occurs, the LP aborts any attempted playback of the content.

At block 246, the LP computes the hash of the revocation list. In one embodiment, the signed hash may be used during decryption processing by the LP. At block 248, the LP decrypts 107 at least a portion of the encrypted content 105 using a key corresponding to the key used during encryption processing 103 by the LR. The decrypted content may then be rendered for perception by the user of the LP. At block 250, the LP computes the hash of at least a portion of the decrypted content 104 as the content is being played for the user. In one embodiment, decryption, rendering and comparison of hashes may be performed on blocks of content data. At block 252, the LP compares the hash computed at block 250 with data from the signed hash 126 in the title received from the LR. If the hashes do not match, then it may be assumed that the content has been tampered with or the content does not match the signed hash and the LP aborts playback of the content.

In one embodiment, the hash 130 may be computed on either encrypted or unencrypted content. When the content is unencrypted, the encrypt and decrypt operations may be omitted. The revocation list may then be included the content hash calculation, thereby associating the revocation list with the content.

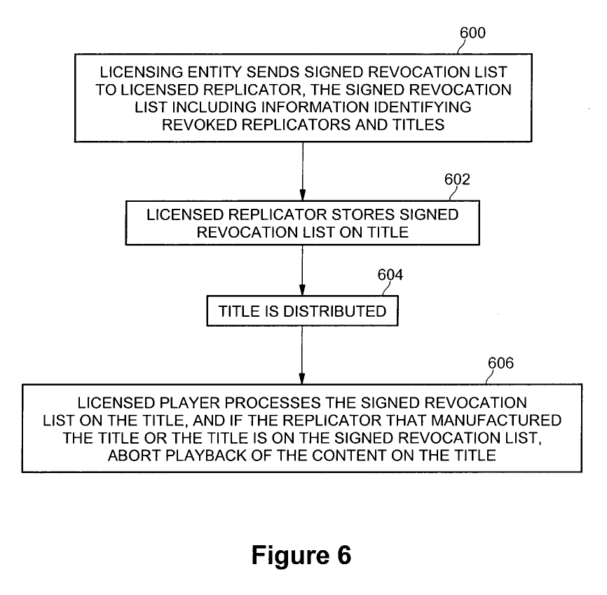

FIG. 6 is a flow diagram illustrating revocation list processing according to an embodiment of the present invention. At block 600, a LE sends a signed revocation list to a LR. The signed revocation list includes information identifying at least one revoked replicator, certificate, and/or titles. At block 602, the LR stores the signed revocation list on a title. The title is then distributed at block 604. At block 606, an LP processes the signed revocation list included on the title, and if the replicator that manufactured the title is on the revocation list (e.g., authorization for the replicator to reproduce the content has been revoked) or the title or its corresponding certificate is on the revocation list, the LP aborts playback of the title's content.

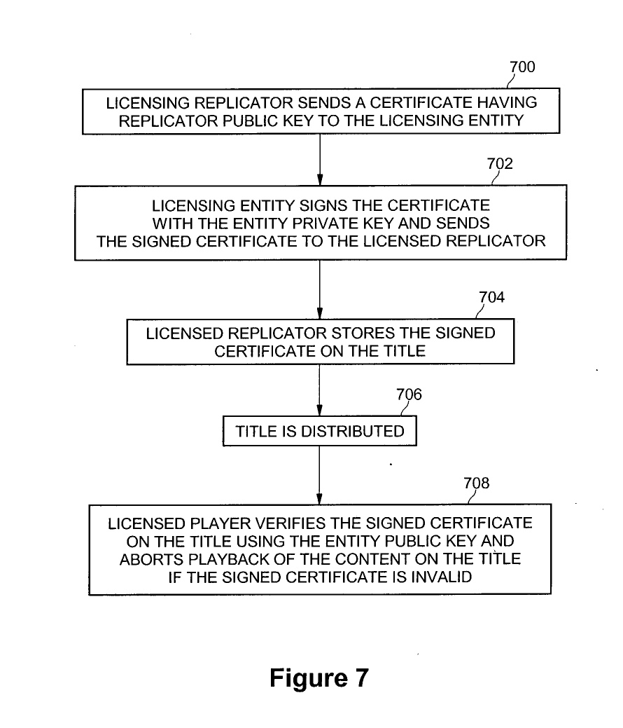

FIG. 7 is a flow diagram illustrating certificate processing according to an embodiment of the present invention. At block 700, a LR sends a digital certificate having the replicator's public key to a LE. At block 702, the LE signs the certificate with the LE's private key and sends the signed certificate to the LR. In another embodiment, the LE obtains the LR's public key, generates the certificate including the LR's public key, signs the certificate with the LE's private key, and sends the signed certificate to the LR. At block 704, the LR stores the signed certificate on the title. At block 706, the title is distributed. At block 708, when a user desires to see and/or hear the title's content, the LP verifies the signed certificate on the title using the LE's public key (stored in the LP during manufacturing of the LP or at a time prior to use of the LP by the user) and aborts playback of the title's content if the signed certificate is invalid.

Embodiments of the present invention are intended to thwart mass distribution of unauthorized titles, and may be effective for content not yet otherwise legitimately distributed in a given format (e.g., a movie that is still running in theatres). Embodiments of this invention may be used by replicators of DVD video titles, and by the manufacturers of devices and applications that play such titles. In one embodiment, the titles may be in high definition DVD format. Note that embodiments of the invention may be applied to both content that is encrypted by a content protection system, and content that is distributed in unencrypted form. Also, while the present invention was described herein in terms of pre-recorded titles, note that it could also be applied to content recorded by consumers, in which case the replicator certificate 110 may be replaced by a consumer's recording certificate.

Although the foregoing operations have been described as a sequential process, some of the operations described in FIGS. 1, and 3-7 may in fact be performed in parallel or concurrently. In addition, in some embodiments the order of the operations may be rearranged without departing from the spirit of the invention.

The techniques described herein are not limited to any particular hardware or software configuration; they may find applicability in any computing, consumer electronics, or processing environment. The techniques may be implemented in hardware, software, or a combination of the two. The techniques may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, that may include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method of managing production of a title including content comprising:
obtaining a signed certificate from a trusted entity, the signed certificate including a public key, and inserting the signed certificate into the title;
computing a hash of the content, signing the hash with a private key corresponding to the certificate public key, and inserting the signed hash into the title;
inserting the content into the title; and
distributing the title.

2. The method of claim 1, further comprising:
creating the certificate;
generating the public key;
inserting the public key into the certificate; and
sending the certificate to the trusted entity;
wherein the creating, generating, inserting the public key, and sending occur before obtaining the signed certificate from the trusted entity.

3. The method of claim 1, further comprising:
generating the public key; and
sending the public key to the trusted entity prior to obtaining the signed certificate.

4. The method of claim 1, further comprising:
encrypting the content prior to inserting the content into the title.

5. The method of claim 1, further comprising:
obtaining usage rules for the content from a content provider; and
including the usage rules in computation of the hash of the content.

6. The method of claim 1, wherein obtaining the signed certificate comprises obtaining a unique signed certificate for every title produced.

7. The method of claim 1, further comprising:
obtaining a signed revocation list from the trusted entity, the signed revocation list including information identifying at least one of a title, a certificate, and a replicator; and
inserting the signed revocation list into the title prior to distributing the title.

8. The method of claim 7, further comprising:
computing a hash of the signed revocation list; and
including the hash of the signed revocation list as part of encrypting the content prior to inserting the content into the title.

9. The method of claim 7, further comprising:
including the signed revocation list in computation of the hash of the content.

10. The method of claim 1, wherein the content comprises at least one of audio, visual, and audiovisual content.

11. The method of claim 9, wherein the title is embodied on an optical storage medium.

12. An article comprising: a storage medium having a plurality of machine accessible instructions, wherein when the instructions are executed by a processor, the instructions provide for the managing of production of a title including content, the instructions including
obtaining a signed certificate from a trusted entity, the signed certificate including a public key, and inserting the signed certificate into the title;
computing a hash of the content, signing the hash with a private key corresponding to the public key, and inserting the signed hash into the title; and
inserting the content into the title.

13. The article of claim 12, further comprising instructions for:
creating the certificate;
generating the public key inserting the public key into the certificate; and
sending the certificate to the trusted entity;
wherein the creating, generating, inserting the public key, and sending occur before obtaining the signed certificate from the trusted entity.

14. The article of claim 12, further comprising instructions for:
generating the public key; and
sending the public key to the trusted entity prior to obtaining the signed certificate.

15. The article of claim 12, further comprising instructions for:
encrypting the content prior to inserting the content into the title.

16. The article of claim 12, further comprising instructions for:
obtaining usage rules for the content from a content provider; and
including the usage rules in computation of the hash of the content.

17. The article of claim 12, wherein instructions for obtaining the signed certificate comprise instructions for obtaining a unique signed certificate for every title produced.

18. The article of claim 12, further comprising instructions for:
obtaining a signed revocation list from the trusted entity, the signed revocation list including information identifying at least one of a title, a certificate, and a replicator; and
inserting the signed revocation list into the title.

19. The article of claim 18, further comprising instructions for:
computing a hash of the signed revocation list; and
including the hash of the signed revocation list as part of encrypting the content prior to inserting the content into the title.

20. The article of claim 18, further comprising instructions for including the signed revocation list in computation of the hash of the content.

21. The article of claim 12, wherein the content comprises at least one of audio, visual, and audiovisual content.

22. The article of claim 12, wherein the title is embodied on an optical storage medium.

23. A method of processing a title by a player, the title including content for rendering by the player, comprising:
reading a signed certificate from the title, verifying a first signature of the signed certificate using a public key of a trusted entity, and aborting processing of the title when the first signature is invalid; and
reading a signed hash from the title, verifying a second signature of the signed hash using a public key obtained from the signed certificate, and aborting processing of the title when the second signature is invalid.

24. The method of claim 23, further comprising:
storing the trusted entity public key into the player prior to processing the title.

25. The method of claim 23, further comprising:
reading a signed revocation list from the title, verifying a third signature of the signed revocation list using the trusted entity public key, and aborting processing of the title when the third signature is invalid.

26. The method of claim 25, further comprising:
replacing a stored revocation list with the signed revocation list from the title when the signed revocation list from the title is newer than the stored revocation list.

27. The method of claim 26, further comprising:
processing the newer of the signed revocation list from the title and a previously stored revocation list to determine if the received or previously storedrevocation list includes information identifying at least one of the title, the certificate, and the replicator producing the title; and
aborting processing of the title when the received or previously stored revocation list includes information identifying at least one of the title, the certificate, and the replicator producing the title.

28. The method of claim 23, further comprising:
rendering the content.

29. The method of claim 23, further comprising:
decrypting the content; and
rendering the content.

30. The method of claim 29, further comprising:
computing a hash of the signed revocation list; and
including the hash of the signed revocation list as part of decrypting the content.

31. The method of claim 23, further comprising:
computing a hash of at least a portion of the content;
comparing the computed hash to the signed hash received in the title; and
aborting processing of the title when the hashes do not match.

32. The method of claim 31, wherein a signed revocation list read from the title is included in computing the content hash.

33. The method of claim 23, wherein the content comprises at least one of audio, visual, and audiovisual content.

34. The method of claim 23, wherein the title is embodied on an optical storage medium.

35. An article comprising: a storage medium having a plurality of machine accessible instructions, wherein when the instructions are executed by a processor, the instructions provide for processing of a title by a player, the title including content for rendering by the player, the instructions including
reading a signed certificate from the title, verifying a first signature of the signed certificate using a public key of a trusted entity, and aborting processing of the title when the first signature is invalid; and
reading a signed hash from the title, verifying a second signature of the signed hash using a public key obtained from the signed certificate, and aborting processing of the title when the second signature is invalid.

36. The article of claim 35, further comprising instructions for:
storing the trusted entity public key into the player prior to processing the title.

37. The article of claim 35, further comprising instructions for:
reading a signed revocation list from the title, verifying a third signature of the signed revocation list using the trusted entity public key, and aborting processing of the title when the third signature is invalid.

38. The article of claim 37, further comprising instructions for:
replacing a stored revocation list with the signed revocation list from the title when the signed revocation list from the title is newer than the stored revocation list.

39. The article of claim 38, further comprising instructions for:
processing the newer of the signed revocation list from the title and a previously stored revocation list to determine if the signed revocation list from the title or the previously stored revocation list includes information identifying at least one of the title, the certificate, and the replicator producing the title; and
aborting processing of the title when the signed revocation list from the title or the previously stored revocation list includes information identifying at least one of the title and the replicator producing the title.

40. The article of claim 35, further comprising instructions for:
rendering the content.

41. The article of claim 35, further comprising instructions for:
decrypting the content; and
rendering the content.

42. The article of claim 41, further comprising instructions for:
computing a hash of the signed revocation list; and
including the hash of the signed revocation list as part of decrypting the content.

43. The article of claim 35, further comprising instructions for:
computing a hash of at least a portion of the content;
comparing the computed hash to the signed hash received in the title; and
aborting processing of the title when the hashes do not match.

44. The article of claim 43, wherein a signed revocation list from the title is included in computing the content hash.

45. The article of claim 35, wherein the content comprises at least one of audio, visual, and audiovisual content.

46. The article of claim 35, wherein the title is embodied on an optical storage medium.

47. A method of operating a trusted entity comprising:
signing a certificate with a private key to form a signed certificate;
sending the signed certificate to a replicator for insertion into one or more titles;
creating a revocation list, the revocation list including information identifying at least one of a title, a certificate, and a replicator;
signing the revocation list with the private key; and
sending the signed revocation list to at least one replicator for insertion into titles.

48. The method of claim 47, further comprising:
receiving the certificate from the replicator prior to signing the certificate.

49. The method of claim 47, further comprising:
creating the certificate prior to signing the certificate.

50. The method of claim 47, further comprising:
sending a public key corresponding to the private key to a manufacturer of a player.

51. The method of claim 47, further comprising:
updating the revocation list;
signing the updated revocation list with the private key; and
sending the updated signed revocation list to at least one replicator for insertion into titles.

52. An article comprising: a storage medium having a plurality of machine accessible instructions, wherein when the instructions are executed by a processor, the instructions provide for operating a trusted entity, the instructions including
signing the certificate with a private key to form a signed certificate;
sending the signed certificate to a replicator for insertion into one or more titles;
creating a revocation list, the revocation list including information identifying at least one of a title, a certificate, and a replicator;
signing the revocation list with the private key; and
sending the signed revocation list to at least one replicator for insertion into titles.

53. The article of claim 52, further comprising instructions for:
receiving the certificate from the replicator prior to signing the certificate.

54. The article of claim 52, further comprising instructions for:
creating the certificate prior to signing the certificate.

55. The article of claim 52, further comprising instructions for:
updating the revocation list;
signing the updated revocation list with the private key; and
sending the updated signed revocation list to at least one replicator for insertion into titles.

56. An apparatus for processing a title, the title including content for rendering by the apparatus for perception by a user, comprising:
logic to read a signed certificate from the title, to verify a first signature of the signed certificate using a public key of a trusted entity, and to abort processing of the title when the first signature is invalid; and
logic to read a signed hash from the title, to verify a second signature of the signed hash using a public key obtained from the signed certificate, and to abort processing of the title when the second signature is invalid.

57. The apparatus of claim 56, further comprising:
logic to read a signed revocation list from the title, to verify a third signature of the signed revocation list using the trusted entity public key, and to aborting processing of the title when the third signature is invalid.

58. The apparatus of claim 57, further comprising:
logic to process the newer of the signed revocation list from the title and a previously stored revocation list to determine if the signed revocation list from the title or the previously stored revocation list includes information identifying at least one of the title, the certificate, and the replicator producing the title, and to abort processing of the title when the signed revocation list from the title or the previously stored revocation list includes information identifying at least one of the title, the certificate, and the replicator producing the title.

59. The apparatus of claim 56, further comprising:
logic to decrypt the content.

60. The apparatus of claim 56, further comprising:
logic to compute a hash of at least a portion of the content, to compare the computed hash to the signed hash received in the title, and to abort processing of the title when the hashes do not match.

61. The article of claim 56, wherein the content comprises at least one of audio, visual, and audiovisual content, the title is embodied on an optical storage medium, and the apparatus comprises an optical storage medium player.

62. A method of processing a title, the title including content, comprising:
sending a signed revocation list from a first entity to a second entity, the signed revocation list including information identifying at least one of a revoked replicator, a revoked certificate, and a revoked title; and
storing, by the second entity, the signed revocation list on the title.

63. The method of claim 62, further comprising processing the signed revocation list stored on the title by a third entity, and aborting rendering of the content stored on the title when at least one of a revoked replicator, the certificate, and the title is included on the newer of the signed revocation list and a previously stored revocation list.

64. The method of claim 62, wherein the content comprises at least one of audio, visual, and audiovisual content, and the title is embodied in an optical storage medium.

65. The method of claim 62, further comprising distributing the title by the second entity.

66. A method of processing a title, the title including content, comprising:
signing a certificate having a public key of a second entity by a first entity using the first entity's private key;
sending the signed certificate from the first entity to the second entity; and
storing, by the second entity, the signed certificate on the title.

67. The method of claim 66, further comprising verifying, by a third entity and using the first entity's public key corresponding to the first entity's private key, the signed certificate stored on the title, and aborting rendering of the content of the title when the signed certificate is invalid.

68. The method of claim 66, wherein the content comprises at least one of audio, visual, and audiovisual content, and the title is embodied in an optical storage medium.

69. The method of claim 66, further comprising distributing the title by the second entity.
